(19) United States
(12) Patent Application Publication
(10) Pub. No.: US 2003/0069347 A1
(43) Pub. Date: Apr. 10, 2003

(54) Calcined silica particle and manufacturing method of same

(76) Inventors: Hideki Oishi, Himeji-shi (JP); Shuji Shimizu, Himeji-shi (JP); Jiro Iriguchi, Kakogawa-shi (JP)

Correspondence Address: NIXON & VANDERHYE P.C., 8th Floor, 1100 North Glebe Road, Arlington, VA, 22201, US

(21) Appl. No.: 10/253,898

(22) Filed: Sep. 25, 2002

(30) Foreign Application Priority Data
Sep. 28, 2001 (JP) 2001-304289

(51) Int. Cl. C01B 33/12; C08K 3/34

(52) U.S. Cl. 524/492; 423/335; 524/493

(57) ABSTRACT

Provided is a calcined silica particle and a manufacturing method of the same, the calcined silica particle having a low hygroscopicity, and a narrow range of particle size distribution, and substantially even particle diameter, and containing little of large-diameter fused aggregation of the particulates of the calcined silica particle. A silica particle is obtained by hydrolyzing and condensing a hydrolyzable silicon compound in an organic solvent containing water, for example, at a reaction temperature ranging from 0° C. to 50° C., and then dried. Then, the silica particle is calcined at a temperature ranging from 1000° C. to 1200° C. It is preferable that the organic solvent contains the silicon compound in a range between 0.05 to 1.2 mol/L, the water in a range between 2.0 to 25.0 mol/L, and a catalyst in a range between 0.8 to 9.4 mol/L. The calcined silica particle has an average particle diameter ranging between 0.04 μm and 5.0 μm; a standard deviation of the average particle diameter of 1.3 μm or less; a moisture absorption amount of 0.2 wt % or less, measured after the calcined silica particle is kept for 1 day in an environment at 30° C. and at 90% relative humidity; and a content of a fused aggregation of the calcined silica particle of 0.02 wt % or less, the fused aggregation having a particle diameter of 20 μm or more.

### FIELD OF THE INVENTION

The present invention relates to a calcined silica particle, which is suitable for use as a filler of a resin used as a sealant of a semiconductor element, a dental material or the like for example, and a manufacturing method of the same.

### BACKGROUND OF THE INVENTION

Conventionally, known as a manufacturing method of a calcined silica particle is a method including the steps of hydrolyzing an organic silicon compound in an alcoholic solvent so as to obtain a hydrate; condensing the thus obtained hydrate to obtain a silica particle; drying and granulating the silica particle, by spray drying or the like method; calcining the thus dried and granulated silica particle; and then classifying the calcined silica particle, thereby manufacturing a calcined silica particle having a desired particle diameter. The calcined silica particle is used as a filler of a curing resin composition used as, for example, a sealant of a semiconductor element, a dental material, and the like.

However, the calcined silica particle thus obtained by the aforementioned conventional method has a high hygroscopicity and a property to generate water when heated at a high temperature, because the calcined silica particle has silanol group [≡SiOH, ═Si(OH)₂, —Si(OH)₃]. Therefore, when used as a filler of a curing resin composition used as, for example, a sealant of a semiconductor element, a dental material, and the like, the calcined silica particle has such a problem that the calcined silica particle deteriorates the cured resin composition. The problem is raised when the silica particle is used, as a filler, in various resin composition used as the sealant of the semiconductor element or the dental material, where a matrix resin is made of a curing resin such as an epoxy resin and an unsaturated polyester resin, or a curing acryl resin having a good photo-polymerization property. Specifically, when used at a high temperature or when used for a significant period of time, the cured product using the resin composition is deteriorated, because of the hygroscopicity of the filler, or the water generated. Specifically, when the calcined silica particle is used as the filler of the curing resin composition used as the sealant of the semiconductor element, the deterioration of the cured resin composition leads to a serious defect. Moreover, when the calcined silica particle is used as the filler used in a photo-curing resin composition that is used as the dental material, the resin composition cannot have a high filling density. The lack of the high filling density gives the cured resin composition a low strength, thereby causing such problems that the dental material is easily come off from a tooth in which the dental material is filled. Moreover, even after cured in dental treatment, the dental material tends to be easily come off, because the cured dental material absorb water in elapse of time, in case such filler having a high hygroscopic property is included in the dental material.

Furthermore, the silica particle thus obtained by condensing the hydrate (such as silica particles obtained by methods disclosed in Japanese publication of unexamined patent application, Tokukaisho, No. 62-96313 (published on May 2, 1987), and Japanese publication of unexamined patent application, Tokukaihei, No. 1-234319 (published on Sep. 19, 1989)) has a narrow range of particle size distribution, and thus has a substantially even particle. However, the silica particle thus obtained by drying includes particulates of the silica particle, which are aggregated with each other, because a spray drying apparatus is used for drying the silica particle. (Note that in the present Specification, the word “particle” is used to refer to a kind of particle, that is, the word particle is used as a collective noun, while the word “particulate” is used to refer to an individual piece of the “particle.) Therefore, the calcining causes the silica particle to be fused together, thereby producing a fused aggregation of particulates of the calcined silica particle (fused aggregation of the calcined silica particle). Thus, the calcined silica particle produced by calcining the silica particle, which is described in the Japanese publication, includes the fused aggregation (large fused aggregation) having a large particle diameter. If such calcined silica particle including the fused aggregation is used as a filler of a photo-curing resin composite, for example, used as a sealant for a semiconductor element for under-filling (under-filling semiconductor element), which is highly accurate, (is required to be highly accurate) or as a dental material, sometime a life (reliability) of a cured product, which is produced by curing the resin compound, may not be sufficiently long (high). Moreover, the resin composition including the calcined silica particle cannot have a sufficiently high filling density. Thus, the calcined silica particle is not suitable for use in the dental material, which should be securely filled in a narrow space.

Moreover, the sealant of the semiconductor that uses a silica particle obtained by a method described in Japanese publication of unexamined patent application, Tokukaihei, No. 4-240110 (published on Aug. 27, 1992), has a difficulty to have a high filling ratio, because the silica particle of the Japanese publication has a broad range of particle size distribution. Moreover, a calcined silica particle prepared by a method described in Japanese publication of unexamined patent application, Tokukaihei, No. 3-288538 (published on Dec. 18, 1991) uses a vacuum evaporator as the drying apparatus. In this method, the calcining is carried out at a relatively low calcining temperature, namely, in a range of 300° C. to 800° C. As a result, the calcined silica particle has a large quantity of the silanol group on its surface. Furthermore, this calcining causes the calcined silica particle to have a large number of pores on its surface, thereby making the calcined silica particle have a high hygroscopicity.

### SUMMARY OF THE INVENTION

The present invention has an object of providing a calcined silica particle capable of being suitably used as a filler of a resin used as, for example, a sealant of a semiconductor element, a dental material, and the like.

In order to attain the above object, a calcined silica particle of the present invention, obtained by calcining a silica particle, is arranged such that the calcined silica particle has an average particle diameter in a range between 0.04 μm and 5.0 μm; a standard deviation of the average particle diameter of 1.3 μm or less; a moisture absorption amount of 0.2% by weight or less, where the moisture absorption amount is measured after the calcined silica particle is kept for 1 day in an environment at a temperature of 30° C. and at 90% relative humidity; and a content of a fused aggregation of the calcined silica particle of 0.02% by weight or less, the fused aggregation of the calcined silica particle having a particle diameter of 20 μm or more.

Specifically, the calcined silica particle of the present invention is so arranged that the silica particle is obtained by hydrolyzing and condensing a hydrolyzable silicon compound in an organic solvent containing water and a catalyst.

With the above-mentioned arrangement, the calcined silica particle has a low hygroscopicity and a narrow range of particle size distribution, thus having a substantially even particle size and having little amount of the fused aggregation having a large particle diameter. Therefore, when the calcined silica particle is used, for example, as a filler of a photo-curing resin composition used as a dental material, the photo-curing resin composition can be filled with a high filling density and a cured produced obtained by curing the photo-curing resin composition can have a greater strength. Moreover, when the calcined silica particle is, for example, used as a filler of a curing resin composition used as a sealant of a semiconductor element, it is possible to give the curing resin composition a high gap accuracy without deteriorating the curing resin composition, because the calcined silica particle has very little quantity of the large fused aggregation of the particulates. With this arrangement, it is possible to provide a calcined silica particle suitably used for a filler of a curing resin composition used as a sealant of under-filling semiconductor element, which is highly accurate, or a dental material. Note that a cured (hardened) product that is produced by curing the curing resin composition containing the calcined silica particle of the present invention is durable (does not tend to be deteriorated) after cured, because the filler contained therein has a very low hygroscopicity. Therefore, the cured product or a cured filling material using the curing resin composition containing the calcined silica particle has a high durability and a long life. Thus, the curing resin composition, which uses, as the filler, the calcined silica particle of the present invention, and which can provide such cured product and cured filling material, is preferable.

In order to attain the above object, a manufacturing method of a calcined silica particle of the present invention includes the step of hydrolyzing and condensing a hydrolyzable silicon compound in an organic solvent containing water and a catalyst, so as to obtain a silica particle; drying the silica particle; and calcining the silica particle at a temperature in a range between 1000° C. and 1200° C.

Specifically, the manufacturing method of the calcined silica particle of the present invention is so arranged the organic solvent contains the silicon compound having a concentration in a range between 0.05 mol/L and 1.2 mol/L, the water having a concentration in a range between 2.0 mol/L and 25.0 mol/L, and the catalyst having a concentration in a range between 0.8 mol/L and 9.4 mol/L.

The manufacturing method of the calcined silica particle of the present invention is so arranged that the step of hydrolyzing and condensing is carried out at a reaction temperature in a range between 0° C. and 50° C.

More preferably, the manufacturing method of the calcined silica particle of the present invention, wherein the step of drying uses an instantaneous vacuum evaporating apparatus. In case the instantaneous vacuum evaporating apparatus is used, the dried silica particle are individually dispersed, and will be still individually dispersed after calcining in the next step, thereby suppressing formation of fused aggregation of particulates of the calcined silica particle. Alternatively, the manufacturing method of the calcined silica particle of the present invention may be so arranged that the step of drying uses a spray drying method, and to include the step of grinding the silica particle so that the thus ground silica particle is calcined in the step of calcining, prior to the step of calcining. When the spray drying apparatus is used to dry the silica particle, the silica particle is dried, which is aggregated. If such silica particle is calcined as it is, particulates of the silica particle are fused together, thus failing to obtain individually dispersed silica particle. However, by having the step of grinding after drying the silica particle by using the spray drying apparatus, it is possible to suppress the formation of the fused aggregation of the silica particle during the calcining of the silica particle.

With the above arrangement, it is possible to manufacture inexpensively a calcined silica particle having a low hygroscopicity, a narrow range of particle size distribution, and substantially even particle diameter, and containing little of fused aggregation having a large particle diameter.

For a fuller understanding of the nature and advantages of the invention, reference should be made to the ensuing detailed description taken in conjunction with the accompanying drawings.

### DESCRIPTION OF THE EMBODIMENTS

Described below is an embodiment of the present invention. A calcined silica particle of the present invention, obtained by calcining a silica particle, has an average particle diameter in a range between 0.04 μm and 5.0 μm; a standard deviation of the average particle diameter of 1.3 μm or less; a moisture absorption amount of 0.2% by weight or less, where the moisture absorption amount is measured after the calcined silica particle is kept for 1 day in an environment at a temperature of 30° C. and at 90% relative humidity; and a content of a fused aggregation of the calcined silica particle of 0.02% by weight or less, the fused aggregation of the calcined silica particle having a particle diameter of 20 μm or more. A manufacturing method of a calcined silica particle, of the present invention includes the step of hydrolyzing and condensing a hydrolyzable silicon compound in an organic solvent containing water and a catalyst, so as to obtain a silica particle; drying the silica particle; and calcining the silica particle at a temperature in a range between 1000° C. and 1200° C.

In the present invention, “silica” refers to an oxide of silicon, in which a silicon atom forms a 3-dimensional network by forming bonds mainly with oxygen atoms. Assumed that a compound represented by the following composition formula, in which an organic group is directly bound to one or some of the silica atoms that form a network, is categorized into the oxide of silicon:

RₙSiO_{(4-n)/2}

where R is an organic group containing a carbon atom directly bound to a silicon atom, and n denotes a numerical value, 0 or 1.

The silicon compound, which is a raw material of the calcined of the present invention, is only required to be hydrolyzable and to be such a compound (organic silicon compound) that can form a hydrate by hydrolysis. Specifically, preferable is a silane compound represented by the following composition formula:

R′ₘSiX₄₋ₘ

where R′ represents at least an organic group selected from the group consisting of an alkyl group, an aryl group, and an unsaturated aliphatic residual group, which contain 1 to 10 carbon atoms, and which may have a substituent, X represents at least a hydrolyzable group selected from the group consisting of a hydrogen atom, a halogen atom, a hydroxyl group, an alkoxy group, and an acyloxy group, and m represents an integer ranging from 0 to 3. The reason why such silane compound is preferable is that such silane compound is industrially produced with ease and is inexpensive.

However, if only the silane compound in which the integer represented by m in the composition formula is 2 or 3, and/or its derivative, is used as the raw material, it is impossible to form a 3-dimensional network, thereby failing to obtain silica. Therefore, such silane compound and/or its derivative is used as the raw material, together with the silane compound in which the integer represented by m in the composition formula is 0 or 1, and/or its derivative.

Examples of the silane compound are, specifically: chlorosilane compounds such as tetrachlorosilane, methyltrichlorosilane, phenyltrichlorosilane, dimethyldichlorosilane, diphenyldichlorosilane, methylvinyldichlorosilane, trimethylchlorosilane, and methyldiphenylchlorosilane; alkoxysilane compound such as tetramethoxysilane, tetraethoxysilane, tetraisopropoxysilane, tetrabuthoxylsilane, methyltrimethoxysilane, methyltriethoxysilane, trimethoxylvinylsilane, triethoxylvinylsilane, 3-glycidoxypropyltrimethoxysilane, 3-chloropropyltrimethoxylsilane, 3-mercaptopropyltrimethoxysilane, 3-(2-aminoethylamino)propyltrimethoxylsilane, phenyltrimethoxysilane, phenyltriethoxysilane, dimethyldimethoxylsilane, dimethyldiethoxysilane, 3-glycidoxypropylmethyldimethoxysilane, 3-glycidoxypropylmethyldiethoxylsilane, 3-chloropropylmethyldimethoxysilane, diphenyldimethoxysilane, diphenyldiethoxysilane, dimethoxydiethoxysilane, trimethylmethoxysilane, and trymethylethoxysilane; acyloxysilane such as tetraacetoxysilane, methyltriacetoxysilane, phenyltriactoxysilane, dimethyldiacetoxysilane, diphenyldiacetoxysilane, trimethylacetoxysilane; and silanol compounds such as dimethylsilanediole, diphenylsilanediole, and trimethylsilanol. Among the examples of the silane compound, alkoxysilanes are especially preferable because alkoxysilanes are easy to obtain, and no halogen atom will be contained, as impurity, in the calcined silica particle, when an alkoxysilane is used. It is preferable that the calcined silica particle of the present invention has a substantial 0% content of halogen atom, and no halogen atom is detected in the calcined silica particle.

Examples of the silicon compound other than the silane compounds are (a) a compound (a derivative of the silane compound) in which part of a hydrolyzable group represented by X in the composition formula is a group capable of forming a chelate structure, such as a carboxyl group or β-dicarbonyl group, and (b) a low condensation product that is obtained by partially hydrolyzing a silane compound or a derivative thereof. As to the silicon compound, only one kind of the silicon compound may be used, or two or more kinds of the silicon compound may be used together.

The raw material, that is, the silicon compound, is hydrolyzed in an organic solvent containing water, so as to form a hydrate. The hydrate is condensed so as to produce a suspension of a silica particle (particulates of silica) in a spherical form.

Specifically, the hydrolysis is carried out as follows. For example, the following methods may be adopted: a method in which the silicon compound (raw material) is added into the organic solvent at once and stirred; a method in which the silicon compound is added into the organic solvent in several times with a stir; and a method in which the silicon compound is continuously added into the organic solvent with a stir. Moreover, it is also possible to add a solution, which is prepared by dissolving the silicon compound in part of the organic solvent, into the rest of the organic solvent, by adopting any one of the aforementioned methods. Furthermore, if necessary, a basic catalyst (hereinafter, just referred to as a catalyst), such as ammonia, urea, ethanolamine, tetramethylammoniumhydroxide, may be added when performing the hydrolysis. Among those, ammonia is more preferable.

The organic solvent may be any compound that is capable of dissolving the silicon compound (raw material), and dissolving water and the catalyst (if necessary) or dispersing therein water and the catalyst in such a manner that the water and the catalyst are associated with each other (in a micelle form). Examples of the organic solvent is, specifically: alcohols such as methyl alcohol, ethyl alcohol, isopropyl alcohol, n-butyl alcohol, t-butyl alcohol, pentyl alcohol, ethylene glycol, propylene glycol, and 1,4-butanediole; ketones such as acetone, and methylethylketone; esters such as ethylacetate; (cyclo)paraffins such as isooctane and cyclohexane; (cyclo)ethers such as dioxane and diethylether; and aromatic hydrocarbons such as benzene and toluene. Those organic solvents may be used solely or two or more kinds of the organic solvents may be appropriately mixed and used. Among the examples of the organic solvents, alcohols are especially preferable. Note that an organic solvent that is not soluble with water and the catalyst may be used. However, when such organic solvent is used, it is necessary to add a surfactant in order to disperse the water and the catalyst evenly.

It is more preferable that the silicon compound has a concentration in a range between 0.05 mol/L and 1.2 mol/L. Concentrations of the water and the catalyst in the organic solvent affect the resultant silica particle in terms of shapes, particle diameters, and how the silica particle is suspended. Therefore, the water has a concentration, more preferably in a range between 0.1 mol/L and 50.0 mol/L, and further preferably in a range between 2.0 mol/L and 25 mol/L, even though the preferable concentration of the water depends on how much particle diameter is targeted. If the catalyst is used, the catalyst has a concentration more preferably ranging from more than 0, to 10 mol/L or less, and further preferably ranging between 0.8 mol/L and 9.4 mol/L.

Specifically, the water and the catalyst may be added into the organic solvent by the following methods, for example: a method in which the water and the catalyst are added at once in the beginning; a method in which the water and the catalyst are added in several times, and a method in which the water and the catalyst are added continuously. In short, timings when the silicon compound (raw material) is added in the organic solvent, and when the water and the catalyst are added in the organic solvent, may be appropriately set.

With respect to reaction conditions for the hydrolysis and condensation of the silicon compound in the organic solvent containing the water, specifically, for example, reaction temperature is more preferably in a range between 0° C. to 100° C., further preferably in a range between 0° C. and 70° C., and especially preferably in a range between 0° C. and 50° C. Reaction time is more preferably in a range between about 30 minutes and about 100 hours.

Therefore, the most preferable reaction conditions for the hydrolysis and condensation are as follows: in the organic solvent, the silicon compound has a concentration in a range between 0.05 mol/L and 1.2 mol/L, the water has a concentration in a range between 2.0 mol/L and 25 mol/L, the catalyst has a concentration in a range between 0.8 mol/L and 9.4 mol/L, and the reaction temperature is in a range between 0° C. and 50° C.

By hydrolyzing and condensing the silicon compound (raw material) in the organic solvent containing the water, it is possible to obtain a silica particle (particulates), as a suspension thereof, the silica particle having a spherical shape, a narrow range of particle size distribution, and a substantially even particle diameter. Thus, it is possible to efficiently obtain the silica particle of the present invention, having a standard deviation of the average particle diameter of 1.3 μm or less, and a content of fused aggregation of the calcined silica particle of 0.02% by weight or less, the fused aggregation having a particle diameter of 20 μm or more.

A reaction mixture of the silica particle may be filtered via a filter so as to reduce larger particulates. Specifically, used is a filter having a pore size larger than the average particle diameter of the silica particle by 1 μm or more. For example, where the silica particle has an average particle diameter of 2 μm, the reaction mixture is filtered via a filter having a pore size of 3 μm or more. In this way, the large fused aggregation and the like produced in a liquid interface are preferably removed. The filter may be a mesh having a gap or a gap diameter appropriately set.

The silica particle is separated from the organic solvent and dried. Then, the silica particle is calcined so as to break down silanol group (≡SiOH, ═Si(OH)₂, —(Si(OH)₃), which is hydrophilic, (that is, so as to break down hydroxyl group), and so as to block up pores of the silica particle, thereby obtaining an amorphous calcined silica particle, having a low hygroscopicity, a narrow range of particle size distribution, and a particle diameter substantially even, and containing little large fused aggregation having a large particle size. It is desirable that the calcined silica particle have a silica content of 99.9% by weight, or more. Suitable as a drying method for the silica particle is a drying method using a so-called instantaneous vacuum evaporating apparatus. The silica particle dried by the instantaneous vacuum evaporating apparatus is in an individually separated form (that is, perfectly not-aggregated form), and thus can be calcined in the individually separated form, thereby suppressing the formation of large fused aggregation of the calcined silica particle caused by the fusion of the particulates of the silica particle. Moreover, the spray dry method is also applicable as the drying method. In this case, the silica particle is dried while the particulates of the silica particle are gathered up. If the silica particle is calcined as it is, the fusion of the particulates of the silica particle will be facilitated, thereby forming the fused aggregation, thus failing to obtain the calcined silica particle in the individually separated form. However, after spray dried, fused aggregation is ground by using a grinding apparatus, such as a hummer mill. Therefore, it is possible to suppress the generation of the fused aggregation during the calcining of the silica particle. If the spray drying method is used in the drying step, it is necessary to have the grinding step after the drying step. Therefore, a process including the drying step using the spray drying method is slightly more complicated than a process including the drying step using the instantaneous vacuum evaporating apparatus, which allows the silica particle to be dried in the individually separated form, even if the spray drying method can be used for obtaining the calcined silica particle of the present invention, where the formation of the fused aggregation of the calcined silica particle is suppressed. For this reasons, it is preferable to have the drying step using the instantaneous evaporating apparatus, in order to attain a more simple manufacturing method of the calcined silica particle of the present invention.

In addition, the instantaneous vacuum evaporating apparatus may be a well-known instantaneous vacuum evaporating apparatus. For example, as the instantaneous vacuum evaporating apparatus, a crux-system 8B-type (manufactured by Hosokawa Micron Co., Ltd) may be used. Moreover, in the drying step using the spray drying method, a well-known spray drier may be used. An example of the spray dryer is the spray drier manufactured by Yamato Science Co., Ltd.

A calcining temperature is preferably in a range between 1000° C. and 1200° C., and more preferably in a range 1050° C. and 1100° C. If the calcined temperature is less than 1000° C., the silanol group will remain, thereby giving the resultant calcined silica particle a higher hygroscopicity. If the calcining temperature exceeds 1200° C., the particulates of the silica particle are fused together, thereby forming a fused aggregation (secondary fused aggregation). That is, the resultant calcined silica particle includes the fused aggregation. It is difficult to grind (crush) the fused aggregation even by using a grinding machine (crushing machine). As to calcining time, one-hour calcining time is sufficient, but the calcining time may be set depending on the calcining temperature or the particle diameter of the silica particle. Moreover, the calcining may be carried out in the presence of air.

In order to attain the calcined silica particle of the present invention having the calcined silica particle, it is preferable to adopt the aforementioned drying conditions and the calcining temperature conditions. It is further preferable that the calcining is carried out at the calcining temperature, as the calcining conditions, ranging between 1000° C. and 1200° C., more preferably ranging between 1050° C. and 1100° C., thereby giving the calcined silica particle a smaller BET surface area than a conventional calcined silica particle. With such calcining condition, it is possible to attain a calcined silica particle having a surface that tends not to absorb moisture.

The aforementioned method gives the calcined silica particle a moisture absorption amount of 0.2% by weight. To have the calcined silica particle of the present invention in a more preferable form, the moisture absorption of the calcined silica particle is preferably 0.1% by weight, more preferably 0.07% by weight, and further preferably 0.05% by weight. Note that the moisture absorption amount of the calcined silica particle is a water content (an increase in weight) of the calcined silica particle measured after the calcined silica particle is kept for 1 day in an environment at a temperature of 30° C. and at 90% relative humidity. Note that it is preferable that the measurement of the moisture absorption amount is carried out by using the calcined silica particle that has a water content of 0.5% or less. It should be noted that the calcined silica particles used in later-discussed Examples had a water content of 0.3%. The moisture absorption amount of the calcined silica particle is measured as follows. To begin with, the calcined silica particle is weighed before the calcined silica particle absorbed moisture (before a moisture absorption test is carried out). Next, 5 g of the calcined silica particle is placed on a watch glass having a diameter of 10 cm. By gently tapping a bottom of the watch glass, the calcined silica particle is evenly spread out in the watch glass. After that, the calcined silica particle in the watch glass is kept in the aforementioned environment for one day, until the moisture absorption amount became constant. (The moisture absorption test is carried out.) Next, the calcined silica particle is weighed after the moisture absorption test of the calcined silica particle is carried out in the highly humid environment. It should be noted that the moisture absorption amount of the calcined silica particle of the present invention does not increase substantially even when the moisture absorption test is continued for two to three days. Then, the moisture absorption amount of the calcined silica particle is worked out by the following equation:

{Weight (g) of the calcined silica particle after the moisture absorption test−weight (g) of the calcined silica particle before the moisture absorption test}/weight (g) of the calcined silica particle before the moisture absorption test×100=moisture absorption amount (% by weight) of the calcined silica particle.

In the present invention, the moisture absorption amount of the calcined silica particle is carried out with ten samples, that is, in such a manner that ten samples of the calcined silica particle are prepared on ten watch glasses, and tested in the same condition. The thus measured moisture absorption amounts of the samples of the calcined silica particle are averaged by using the number of the measured samples, that is, 10. The average value of the moisture absorption amounts of the samples is the moisture absorption of the calcined silica particle.

Note that even if the moisture absorption test is carried out for another 2 to 3 days, the calcined silica particle of the present invention is manufactured with the specific calcined condition, so as to break down silanol group on the surface thereof, whereby the calcined silica particle of the present invention has substantially less amount of silanol group than a calcined silica particle that is not calcined at the calcined temperature between 1000° C. and 1200° C. Moreover, the high calcined temperature blocks up the pores on the surface of the calcined silica particle. Thus, it is expected that the calcined silica particle of the present invention have a smaller BET surface area than the calcined silica particle that is not calcined at the calcined temperature between 1000° C. and 1200° C. It is deduced that the difference in the BET surface areas resulted in the difference in the moisture absorption amounts.

Therefore, it is further preferable that the calcined silica particle of the present invention has such a preferable property that the moisture absorption amount of the calcined silica particle measured after three-day moisture absorption test changes (usually increases) from a reference, that is, the moisture absorption amount of the calcined silica particle measure after one-day moisture absorption test, preferably by 30% or less, more preferably by 20% or less, further preferably by 10% or less, and most preferably by 5% or less. This property indicates that the moisture absorption of the calcined silica particle becomes substantially constant within about one day. It is a preferable property of the calcined silica particle that the moisture absorption amount becomes substantially constant within one day, and does not increase largely.

Moreover, the calcined silica particle has an average particle diameter in a range between 0.04 μm and 5.0 μm, and a standard deviation of the average particle diameter of 1.3 μm or less. Furthermore, the calcined silica particle has a content of the fused aggregation of the particulates of the calcined silica particle (the fused aggregation of the calcined silica particle) of 0.02% by weight, the fused aggregation having a particle diameter of 20 μm or more. The content of the fused aggregation is worked out as follows. 10 g of the calcined silica particle is added into 90 g of water so that a resultant mixture has a content of the calcined silica particle of 10% by weight. 2 g of a surfactant is further added to the mixture so as to have a content of the surfactant of 2% by weight. The mixture is subjected to supersonic dispersion for one hour, so as to make a slurry of the mixture. The slurry as is filtered through a 20 μm-mesh, and the mesh, on which the large fused aggregation having a particle diameter of 20 μm or more is captured, is weighed so as to find out the amount of the fused aggregation in weight. Note that sodium dodecylbenzensulfonate is used as the surfactant. The content of the large fused aggregation is calculated by the following equation:

(amount (g) of the large fused aggregation/amount (g) of the calcined silica particle)×100=Content (%) of the large fused aggregation.

In the present invention, the content of the large fused aggregation is an average value of measurements of ten samples.

As described above, with the method of the present invention, the calcined silica particle can be manufactured at a low cost. The calcined silica particle has a low hygroscopicity, and a narrow range of particle size distribution, and thus a substantially even particle diameter, and containing little amount of the fused aggregation of the calcined silica particle, the fused aggregation having a large diameter. Therefore, when the calcined silica particle is used, for example, as a filler of a photo-curing resin composition used as a dental material, the use of the calcined silica particle can give the photo-curing resin composition a higher filling density. Moreover, the use of the calcined silica particle can give the photo-curing resin composition a greater post-curing strength, in other words, improve its cured product to be stronger. Moreover, the use of the calcined silica particle gives the resin composition a property to be more easily filled into a smaller area (that is, a better filling property). Note that, the photo-curing resin composition, which has a better filling density, and whose cured product is stronger, can be preferably applied to the other use or the other usage, besides the dental materials.

Moreover, when the calcined silica particle is, for example, used as a filler of a curing resin composition used as a sealant of a semiconductor element, it is possible to give the curing resin composition a high gap accuracy without deteriorating the curing resin composition, because the calcined silica particle has the better filling property. Moreover, because the resin composition can be filled with a higher density, the cured product obtained by curing the resin composition has a greater strength. This allows the resin composition to be a sealant of a semiconductor element with an improved durability.

Moreover, because of the better filling property, the curing resin composition can be filled into a mold or like with low occurrence of pinholes and filling defects. In addition, the curing resin composition, which has a better filling density, and can be filled excellently, so that the cured product obtained by curing the curing resin composition is improved, can be preferably applied to the other use or the other usage, besides the sealant of the semiconductor. As described above, the calcined silica particle of the present invention can be suitably used a filling agent of a photo-curing or curing resin composition used as a sealant of the under-filling semiconductor element, which is highly accurate, or a dental material, for example.

Moreover, it is also preferable that the curing resin composition containing the matrix resin and the calcined silica particle of the present invention is used as a curing resin composition used as a sealant of a semiconductor element, which is highly accurate. The sealant of the semiconductor element is, specifically, the sealant of the under-filling semiconductor element. Furthermore, it is also preferable that the photo-curing resin composition containing the matrix resin and the calcined silica particle of the present invention is used as a photo-curing resin composition used as a dental material.

Specifically, the curing resin composition is constituted of the calcined silica particle of the present invention (hereinafter, referred to as the present calcined silica particle), and a matrix resin selected from the group consisting an epoxy resin, an unsaturated polyester resin, a vinyl ester resin, a GMA (GMA (Glycidyl Methacrylate) modified acrylic resin. The GMA modified acrylic resin is composed of GMA modified compound and GMA modified polymer. The GMA modified acrylic resin is a resin in which at least one double bond is introduced by means of an addition reaction of GMA. Note that the GMA is glycidyl methacrylate. The curing resin composition may be a photo-curing resin composition.

The modified acryl resin is a resin in which two or more (meta)acryloyl group. Moreover, the epoxy resin is a thermo-condensing curing type resin, whereas the other resins are radical curing type resins. If necessary, the other resin may be a polymerizing monomer having one double bond for polymerization, such as styrene and methacrylate monomer, or may be a cross-linking monomer having two or more double bonds for polymerization, such as triethyleneglycol dimethacrylate and trimethylol propantri methacrylate. Of course, the polymerizing monomer and the cross-linking monomer may be used together. As required, a bridging monomer, such as styrene, triethylene glycol di(meta)acrylate, trimethol propane tri(meta)acrylate, may be added to the resin.

In order to realize a curing resin composition that is used as the sealant of the semiconductor element for under-filling, it is preferable to use the epoxy resin, the unsaturated polyester resin, or the vinyl ester resin. Moreover, in order to realize the photo-curing resin composition as the dental material, it is preferable to use the modified acryl resin, and it is also preferable to use a photo-curing resin.

Here, it is preferable to set the calcined silica particle to be included in the resin composition has 10 to 90 parts by weight, where the resultant resin composition is 100 parts by weight. The amount of the calcined silica particle to be used may be appropriately adjusted depending on purposes.

With respect to an amount of the matrix resin, it is preferably arranged such that 10 parts to 90 parts by weight of the matrix resin is added in the curing resin composition, where the resultant curing resin composition is 100 parts by weight. The amount of the matrix resin may be appropriately set, depending on purposes.

Moreover, only one kind of the calcined silica particle of the present invention may be used solely, or more than two kinds of the present calcined silica particles having different average particle diameters or ranges of particle size distribution may be used together.

When the curing resin composition includes more than two kinds of the present calcined silica particles having different average particle diameters or ranges of particle size distribution, the curing resin composition has a better flowability. Such curing resin composition is suitable for filling a highly accurate mold or a very fine area requiring a highly dense filling.

Note that a ratio between the more than two kinds of the present calcined silica particle may be appropriately set depending on the purposes.

Furthermore, when the curing resin composition is to be the thermo-curing resin composition, if the epoxy resin is used, an amine-type curing agent is added in the resin. If the radical curing type resin, such as the unsaturated polyester resin, the vinyl ester resin, and the modified acryl resin, is used, added in the resin is a radical polymerization initiator, such as an azo-type initiator, or a well-known radical polymerization initiator such as amine-type curing agent. Examples of the well-known radical polymerization initiator are BPO (benzoylperoxide), Bic75 (t-bupylperoxyisopropylcarbonate), PBZ (t-butylperoxybenzoate), and DCP (dicumylparoxide).

With respect to an amount of the radical polymerization initiator, it is preferably arranged such that 0.1 parts to 5 parts by weight of the radical polymerization initiator is added, where the resultant resin composition is 100 parts by weight. The amount of the radical polymerization initiator may be appropriately set, considering which kind of thermal curing resin is desired. If necessary, a well-known accelerator may be added.

Examples of the amine-type curing agent are: imidazoles such as 2-methylimidazole, 2-ethyl-4methylimidazole, 2-phenyl imidazole; benziledimethlamineo; 2,4,6-tris(dimethylaminomethyl)phenol 1,4,-diazabicyclo(2.2.2.)octane; tertiary amines such as 1,8-diazabicyclo(5.4.0.)-7-undecene; and phosphines such as triphenylphosphine.

With respect to an amount of the amine-type curing agent, 0.01% by mass and 10.00% by mass of the amine-type curing agent is preferably added, with respect to a total mass of the epoxy resin. If the amount of the amine-type curing agent is out of this range, a good curing accelerating effect may not be attained. The amine-type curing agent or 0.1% by mass and 5% by mass is more preferably added.

Specifically, examples of the radical polymerization initiator are: organic peroxides such as cumenehydroperoxide, diisopropylbenzenperoxide, di-t-butylperoxide, laurylperoxide, benzoylperoxide, t-butylperoxyisopropylcarbonate, t-butylperoxy-2-ehthylhexanoate, t-amylperoxy-2-ethylhexanoate; and azo compounds such as 2,2′azobis (isobutylnitrile), 1, 1′-azobis(cyclohexanecarnitrile), 2,2′-azobis(2,4-dimethylvaleronitrile), dimethyl 2,2′azobis(2-methylpropionate). Those radical polymerization initiators may be used solely or as a mixture consisting of more than two kinds of the initiators.

Moreover, when the resin composition is to be a photo-curing resin, a well-known photo-polymerization initiator such as benzophenone compound may be further added in the resin composition as a curing agent. Furthermore, as required, a well-known sensitizer may be added in the resin composition.

Well-known photo-polymerization initiators may be used as the photo-polymerization initiator. Specifically, examples of the well-known photo-polymerization initiators are: benzoine and alkylethers thereof such as benzoin, benzoinmethylether, and benzoinethylether; acetophenones such as acetophenone, 2,2-dimethoxy-2-phenylacetophenone, 1,1-dichloroacetophenone; anthoraquinones such as 2-methylanthoraquinone, 2-amylanthoraquinone, 2-t-butylanthoraquinone, and 1-chloroanthraquinone; thioxanthones such as 2,4-dimethylthioxanthone, 2,4-diisopropylthioxanthone, and 2-chlorothoxanthone; ketals such as acetophenonedimethylketal, and benzyldimethylketal; benzophenones such as benzophenone 2-methyl-1-(4-(methylthio)phenyl)-2-morpholino)-propane-1-one and 2-benzyl-2-dimethylamino-1-(4-morpholinophenyl)-butanone-1; acylphosphineoxides; and xanthones. Those photo-polymerization initiators may be used solely or used as a mixture containing more than two kinds of the photo-polymerization initiators.

With respect to an amount of the photo-polymerization initiator, preferably 1 parts to 50 parts by weight, more preferably 3 to 30 parts by weight, and further preferably 3 to 20 parts by weight of the photo-polymerization initiator is added in the resin composition, where the resultant resin composition is 100 parts by weight. If the amount of the photo-polymerization is not enough, a time to radiate the resin to cure should be prolonged, or sufficient strength may not be achieved.

Further, glass fibers, the other inorganic fibers, organic fibers as a reinforcer, a pigment, a lubricant, mold releasing agent, elastomer, and a filling agent other than the present calcined silica particle, may be added in the resin composition, as required.

The present invention will be explained in more detail, referring to Examples and the Comparative Examples. However, it should be noted that the present invention is not limited by those Examples and Comparative Examples. Silica particles and calcined silica particles were measured by following methods, in terms of average particle diameter, standard deviation of the average particle diameter, the moisture absorption amount, and the content of the fused aggregation.

[Average Particle Diameter, and Standard Deviation of Average Particle Diameter]

Ordinary silica particles having a silanol group are dispersed in a solvent, comparatively excellently. Therefore, it is possible to accurately measure such silica particle individually dispersed, in terms of distribution of the particle size, particle diameter, and the standard deviation thereof, by using apparatuses. However, the silica particle and the calcined silica particle of the present invention contain no silanol group (have a silanol content of substantially 0%). Therefore, the silica particle and the calcined silica particle of the present invention are dispersed poorly. Therefore, the aforementioned method cannot be applied to accurately measure the particle size distribution, particle diameter, and the standard deviation thereof.

Therefore, in the present Examples and Comparative Examples, the following method was applied to measure the silica particles (or the calcined silica particle) in terms of the average particle diameter, and the standard deviation of the average particle diameter.

The silica particle was arbitrarily sampled, and then electronic microscopic photographs of the silica particle were taken from five different directions, in such a manner that microscopic magnification was so adjusted that 50 to 100 particulates of the silica particle were present in one photograph. Specifically, if the silica particle (or the calcined silica particle) had an average particle diameter of 1 μm, the photographs were taken with ×10000 magnification. All the particulates shown on the electronic microscopic photographs were callipered to find out the size of the silica particle (or the calcined silica particle). The average particle diameter and the standard deviation of the average particle diameter were calculated by the following equations, based on the results of the callipering:

Average Particle Diameter

$$( d ) = ( {\sum }_{i = 1}^{N} {d}_{i} ) / N$$

Standard Deviation (d+σ_{N-1)}/d,

where N is a number of the particulates measured,

$${σ}_{N - i} = {[ \{ {\sum }_{i = 1}^{N} {( d - {d}_{i} )}^{2} \} / ( N - 1 ) ]}^{1 / 2} .$$

[Moisture Absorption Amount]

The moisture absorption amount of the calcined silica particle was a water content (an increase in weight) of the calcined silica particle measured after the calcined silica particle was kept for 1 day in an environment at a temperature of 30° C. and at 90% relative humidity. It should be noted that the calcined silica particles used in later-discussed Examples had a water content of 0.3%. The moisture absorption amount of the calcined silica particle was measured as follows. To begin with, the calcined silica particle was weighed before the calcined silica particle absorbed moisture (before a moisture absorption test was carried out). Next, 5 g of the calcined silica particle was placed on a watch glass having a diameter of 10 cm. By gently tapping a bottom of the watch glass, the calcined silica particle was evenly spread out in the watch glass. After that, the calcined silica particle in the watch glass was kept in the aforementioned environment for one day, until the moisture absorption amount became constant. (The moisture absorption test was carried out.) Next, the calcined silica particle was weighed after the moisture absorption test of the calcined silica particle was carried out in the highly humid environment. The moisture absorption amount of the calcined silica particle was worked out by the following equation:

{Weight (g) of the calcined silica particle after the moisture absorption test−weight (g) of the calcined silica particle before the moisture absorption test}/weight (g) of the calcined silica particle before the moisture absorption test×100=moisture absorption amount (% by weight) of the calcined silica particle.

In the present invention, the moisture absorption amount of the calcined silica particle was carried out with ten samples, that is, in such a manner that ten samples of the calcined silica particle were prepared on ten watch glasses, and tested in the same condition. The thus measured moisture absorption amounts of the samples of the calcined silica particle were averaged by using the number of the measured samples, that is, 10. The average value of the moisture absorption amounts of the samples was the moisture absorption of the calcined silica particle.

[Content of Fused Aggregation]

The content of the fused aggregation was worked out as follows. 10 g of the calcined silica particle was added into 90 g of water so that a resultant mixture had a content of the calcined silica particle of 10% by weight. 2 g of sodium dodecylbenzensulfonate (surfactant) was further added to the mixture so as to have a content of the surfactant of 2% by weight. The mixture was subjected to supersonic dispersion for one hour, so as to make a slurry of the mixture. The slurry was filtered through a 20 μm-mesh, and the mesh, on which the large fused aggregation having a particle diameter of 20 μm or more was captured, was weighed so as to find out the amount of the fused aggregation in weight. The content of the large fused aggregation was calculated by the following equation:

(amount (g) of the large fused aggregation/amount (g) of the calcined silica particle)×100=Content (%) of the large fused aggregation.

In the Examples and Comparative Examples, the content of the fused aggregation was an averaged value of the measured values of ten samples.

### EXAMPLE 1

675.4 g of methyl alcohol and 263.3 g of aqueous ammonia (water and a catalyst) of 28% by weight were added into a 2L-volumned glass reaction vessel, so as to prepare a reaction mixture, the reaction vessel being provided with a stirrer, a dropping device, and a thermometer. Then, the reaction mixture was adjusted to 20° C. plus or minus 0.5° C. with a stir. A solution prepared by solving 134.5 g of tetramethoxysilane as a silicon compound in 55.9 g of methyl alcohol, was added in the dropping device. The solution was dropped into the reaction mixture in such a manner that the dropping took one hour to complete.

After the completion of the dropping, the reaction mixture was further stirred for one hour, so as to hydrolyze and condense tetramethoxysilane, thereby obtaining a suspension of a silica particle. The silica particle had an average particle diameter of 0.48 μm, and a standard deviation of the average particle diameter was 1.3 μm. The suspension was dried by using an instantaneous vacuum evaporating apparatus, so as to obtain a silica particle (I) in a powder form. As the instantaneous vacuum evaporating apparatus, a crux-system 8B-type (manufactured by Hosokawa Micron Co., Ltd) was used. Moreover, the drying was carried out at a heating cylinder temperature was 175° C. and at a pressure reduced to 200 torr.

The instantaneous vacuum evaporating apparatus was provided with a jacketed stainless steel cylinder (a jacketed cylinder made of stainless steel), a feeding section, and a powder-collecting chamber. The steel cylinder, which had an inner diameter of 8 mm, and a length of 9 mm, was supplied with heated steam. The feeding section fed the suspension to an end of the steel cylinder. The powder-collecting chamber, which was connected to the other end of the steel cylinder and was kept under reduced pressure, was provided with a bag filter for separating powder and steam. The suspension fed from the feeding section was heated while passing the steel cylinder, so as to be separated into powder and steam. The powder was collected by the bag filter, while the steam was condensed and discharged out of the instantaneous vacuum evaporating apparatus.

The thus obtained silica particle (I) was placed in a crucible, and calcined at 1050° C. for 1 hour by using an electric furnace, and then was cooled, and ground by using a grinding machine, thereby obtaining a calcined silica particle (1). The calcined silica particle (1) had an average particle diameter of 0.48 μm, a standard deviation of the average particle diameter of 1.20 μm, and a moisture absorption amount of 0.04% by weight. Moreover, in the calcined silica particle (1), a content of a fused aggregation having a particle diameter of 20 μm or more was 0.01% by weight. The content of such fused aggregation was worked out by filtering, through a 20 μm mesh, a predetermined slurry dispersed by supersonic dispersion (supersonic-dispersed slurry).

### EXAMPLE 2

The silica particle (I), which was obtained in Example 1 and in the powder form, was placed in a crucible and calcined at 1200° C. for one hour, and then was cooled, and ground by using the grinding machine, thereby obtaining a calcined silica particle (2). The calcined silica particle (2) had an average particle diameter of 0.49 μm, a standard deviation of the average particle diameter of 1.27 μm, and a moisture absorption amount of 0.02% by weight, and a content of the fused aggregation of 0.02% by weight.

### EXAMPLE 3

The silica particle (I), which was obtained in Example 1 and in the powder form, was placed in a crucible and calcined at 1000° C. for one hour, and then was cooled, and ground by using the grinding machine, thereby obtaining a calcined silica particle (3). The calcined silica particle (3) had an average particle diameter of 0.48 μm, a standard deviation of the average particle diameter of 1.20 μm, and a moisture absorption amount of 0.07% by weight, and a content of the fused aggregation of 0.01% by weight.

### EXAMPLE 4

65 parts by weight of the calcined silica particle (1) thus obtained in Example 1, and 35 parts by weight of epoxy resin (Epicoat YL983U, manufactured by Yuka Shell Epoxy Co., Ltd.) were mixed and kneaded by using a desktop three-roller mill, thereby obtaining an epoxy resin composition containing the calcined silica particle. Viscosity of the epoxy resin composition was measured by using E-type viscometer (1 rpm, at 25° C.). The measurement showed that the epoxy resin composition had a good flowability at 140000 cps.

### EXAMPLE 5

32.5 parts by weight of the calcined silica particle (1) thus obtained in Example 1, 32.5 parts by weight of the calcined silica particle had been calcined at 1050° C., 35 parts by weight of epoxy resin (Epicoat YL983U, manufactured by Yuka Shell Epoxy Co., Ltd.), and 5 parts by weight of 2-methylimdazole, were mixed and kneaded by using a desktop three-roller mill, thereby obtaining an epoxy resin composition containing the calcined silica particles. Viscosity of the epoxy resin composition was measured by using E-type viscometer (1 rpm, at 25° C.). The measurement showed that the epoxy resin composition had, at 60000 cps, a flowability much more excellent than that of the resin composition of Example 4. Note that the mixing of the epoxy resin and the radical polymerization initiator was carried out at a warmed temperature, in order to facilitate the kneading.

It deduced that the flowability was improved because the Epoxy resin composition of Example 5 included the two calcined silica particles having two different average particle diameters. Therefore, it was concluded that it was a preferable embodiment that the two calcined silica particles having two different average particle diameters, in order to improve flowability of a resin composition including the calcined silica particle of the present invention.

The curing epoxy resin composition, in which the amine-type curing agent was mixed in, was preheated, and then injected into a sealant-use mold, which was heated up to 180° C. and in which a wire to be sealed was placed, by using a plunger after the mold was closed. After that, a pressure was applied onto the mold for 8 minutes, so that the epoxy resin composition was cured. The epoxy resin composition successfully filled up the mold by filling up even a fine structural portion in the mold without a gap. No defect due to a pin hole or inclusion of air was found in a molded product thus produced. Moreover, a photo-curing molding material was prepared as in Example 5, with the exception that the epoxy resin of Example 5 was replaced with 25 parts by weight of an acryl resin (bisphenol A diglycidyl methacrylate) in which a double bound was introduced, and 10 parts by weight of triethyleneglycoldimethacryate), that 3 parts by weight of silane coupling agent was further added, and that 0.5 parts by weight of 2,4,6-trimethylbenzoindiphenlyphosphineoxide was used as the polymerization initiator, instead of the amine-type curing agent. The molding material was tested by the following “curing test and polishability (ability to be polishable) test”, so a to check how hard and how polishable the molding material was. As to moldablity (ability to be moldable), the molding material showed such a good flowability that no filling defect due to failure to fill into a corner of the mold, or inclusion of air was found. Moreover, the molding material had a good photo-curing ability.

[Curing Test and Polishability Test]

The molding material was filled into a stainless steel mold, having an inner diameter of 10 mm and a thickness of 1 mm, and provided with a 0.1 mm-thick cover glass on its bottom surface. Then, a cover glass of the same kind was closely placed on a top of the mold. After that, light was applied on the mold from one side for 60 seconds, then from another side for another 60 seconds, by using a visible light irradiator “GC light” (manufactured by GC Co., Ltd.).

Then, one surface of the thus cured molding material was preliminarily polished by using a #600 sandpaper, and polished by using a dental abrasive soap “Eva light” (manufactured by GC Co., Ltd.), so as to make a polished surface. The polished surface was measured for glossiness. It was showed that the glossiness of the polished surface was excellently 82%.

### EXAMPLE 6

A suspension of a silica particle was prepared in the same fashion as Example 1. Then, the suspension was filtered through a cartridge filter (manufactured by Toyo Filter Paper Co., Ltd.) having a pore diameter of 3 μm, before drying the suspension by using the instantaneous vacuum evaporating apparatus.

After that, the filtered suspension was dried by using the instantaneous vacuum evaporating apparatus as in Example 1, thereby obtaining a dried silica particle (III). The silica particle (III) was placed in a crucible, and calcined at 1050° C. for one hour by using the electrical furnace, and then was cooled, and ground by using the grinding machine (hammer mill), thereby obtaining a calcined silica particle (6). The calcined silica particle (6) had an average particle diameter of 0.50 μm, a standard deviation of the average particle diameter of 1. 18 μm, and a moisture absorption amount of 0.03% by weight. Moreover, as in Example 1, the calcined silica particle (6) has a content of a fused aggregation having a particle diameter of 20 μm or more was 0.01% by weight. The content of such fused aggregation was worked out by filtering, through a 20 μm mesh, a predetermined slurry dispersed by supersonic dispersion (supersonic-dispersed slurry), as in Example 1.

### EXAMPLE 7

A calcined silica particle (7) was obtained in the same manner as Example 1, except that the drying was carried out by using a spray dryer (manufactured by Yamato Science Co., Ltd.) replacing the instantaneous vacuum drying apparatus used in Example 1, under the following conditions, and ground by the hammer mill after dried before the calcining.

| | | |
|---|---|---|
| Condition: | Atomizing Pressure | 2 kg/cm² |
| | Air Flow Rate | 0.3 m³/min |
| | Temperature at Inlet | 150° C. |
| | of the Heating Section | |

The resultant calcined silica particle (7) had an average particle diameter of 0.55 μm, and a standard deviation of the average particle diameter of 1.3 μm. Moreover, as in Example 1, the calcined silica particle (7) had a content of a fused aggregation having a particle diameter of 20 μm or more was 0.01% by weight. The content of such fused aggregation was worked out by filtering, through a 20 μm mesh, a predetermined slurry dispersed by supersonic dispersion (supersonic-dispersed slurry), as in Example 1.

### COMPARATIVE EXAMPLE 1

The same reaction and operation as in Example 1 were carried out in order that tetramethoxysilane was hydrolyzed and condensed, and then dried, thereby obtaining a silica particle (II) in a powder form.

The thus obtained silica particle was placed in a crucible and calcined at 850° C. for 1 hour by using the electric furnace, and then was cooled, and ground by using the grinding machine, thereby obtaining a calcined silica particle (4) for comparison. The calcined silica particle (4) had an average particle diameter of 0.48 μm, a standard deviation of the average particle diameter of 1.22 μm, a content of a fused aggregation having a particle diameter of 20 μm or more was 0.01% by weight. However, the calcined silica particle had a moisture absorption amount of 0.4% by weight, which was out of the preferable range.

### COMPARATIVE EXAMPLE 2

The same reaction and operation as in Example 1 were carried out in order that tetramethoxysilane was hydrolyzed and condensed, and then dried, thereby obtaining the silica particle (II) in a powder form.

The thus obtained silica particle was placed in a crucible and calcined at 1300° C. for 1 hour by using the electric furnace, and then was cooled, and ground by using the grinding machine, thereby obtaining a calcined silica particle (5) for comparison. The calcined silica particle (5) had an average particle diameter of 0.62 μm, and a moisture absorption amount of 0.01% by weight. However, the calcined silica particle (5) had a standard deviation of the average particle diameter of 2.4 μm and a content of a fused aggregation having a particle diameter of 20 μm or more was 0.53% by weight, which were out of the preferable ranges, respectively.

### COMPARATIVE EXAMPLE 3

It was attempted to mix and knead, by using the desktop three-roller mill, 65 parts by weight of a silica particle having an average particle diameter of 0.5 μm and an epoxy resin (Epicoat YL984U, Yuka Shell Epoxy Co., Ltd.) (the silica particle having a standard deviation of the average particle diameter of 3.5 μm, and a content of a fused aggregation having a particle diameter of 20 μm or more was 1.1% by weight). However, viscosity of the mixture of silica particle and the epoxy resin became too extraordinarily high to knead the mixture at normal temperatures.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A calcined silica particle, obtained by calcining a silica particle,
the calcined silica particle having an average particle diameter in a range between 0.04 μm and 5.0 μm; a standard deviation of the average particle diameter of 1.3 μm or less; a moisture absorption amount of 0.2% by weight or less, where the moisture absorption amount is measured after the calcined silica particle is kept for 1 day in an environment at a temperature of 30° C. and at 90% relative humidity; and a content of a fused aggregation of the calcined silica particle of 0.02% by weight or less, the fused aggregation of the calcined silica particle having a particle diameter of 20 μm or more.

2. The calcined silica particle as set forth in claim 1, wherein:
the silica particle is obtained by hydrolyzing and condensing a hydrolyzable silicon compound in an organic solvent containing water and a catalyst.

3. The calcined silica particle as set forth in claim 2, wherein:
the organic solvent contains the silicon compound having a concentration in a range between 0.05 mol/L and 1.2 mol/L, the water having a concentration in a range between 2.0 mol/L and 25.0 mol/L, and the catalyst having a concentration in a range between 0.8 mol/L and 9.4 mol/L.

4. The calcined silica particle as set forth in claim 1, wherein:
the silica particle is obtained by hydrolyzing and condensing a hydrolyzable silicon compound in an organic solvent containing the water and the catalyst, dried, and then calcined at a temperature in a range between 1000° C. and 1200° C., so as to obtain the calcined silica particle.

5. The calcined silica particle as set forth in claim 4, wherein:
the silica particle is dried by using an instantaneous vacuum evaporating apparatus, before the calcining.

6. The calcined silica particle as set forth in claim 4, wherein:
the silica particle is dried by using a spray drying method, and then ground, before the calcining.

7. A manufacturing method of a calcined silica particle, comprising the steps of:
hydrolyzing and condensing a hydrolyzable silicon compound in an organic solvent containing water and a catalyst, so as to obtain a silica particle;
drying the silica particle; and
calcining the silica particle at a temperature in a range between 1000° C. and 1200° C.

8. The manufacturing method of the calcined silica particle as set forth in claim 7, wherein:
the step of drying uses an instantaneous vacuum evaporating apparatus.

9. The manufacturing method of the calcined silica particle as set forth in claim 7, wherein:
the step of drying uses a spray drying method,
the manufacturing method comprising the step of grinding the silica particle so that the thus ground silica particle is calcined in the step of calcining, prior the step of calcining.

10. The manufacturing method of the calcined silica particle as set forth in claim 7, wherein
the organic solvent contains the silicon compound having a concentration in a range between 0.05 mol/L and 1.2 mol/L, the water having a concentration in a range between 2.0 mol/L and 25.0 mol/L, and the catalyst having a concentration in a range between 0.8 mol/L and 9.4 mol/ L.

11. The manufacturing method of the calcined silica particle as set forth in claim 7, wherein:
the step of hydrolyzing and condensing is carried out at a reaction temperature in a range between 0° C. and 50° C.

12. A curing resin composition comprising:
a matrix resin; and
a calcined silica particle, having an average particle diameter in a range between 0.04 μm and 5.0 μm, a standard deviation of the average particle diameter of 1.3 μm or less, a moisture absorption amount of 0.2% by weight or less, where the moisture absorption amount is measured after the calcined silica particle is kept for 1 day in an environment at a temperature of 30° C. and at 90% relative humidity, and a content of a fused aggregation of 0.02% by weight or less, the fused aggregation having a particle diameter of 20 μm or more.

13. The curing resin composition as set forth in claim 12, wherein:
the matrix resin is a resin selected from the group consisting of an epoxy resin, an unsaturated polyester resin, a vinyl ester resin, and a GMA modified acrylic resin.

14. The curing resin composition as set forth in claim 12, being used as a curing resin composition used as a sealant of a semiconductor device.

15. The curing resin composition as set forth in claim 12, being used as a photo-curing resin composition used as a dental material.
